(19) United States
(12) Patent Application Publication
(10) Pub. No.: US 2025/0309477 A1
(43) Pub. Date: Oct. 2, 2025

(54) BATTERY MODULE

(71) Applicant: HONDA MOTOR CO., LTD., Tokyo (JP)

(72) Inventors: Hirokazu WATANABE, Saitama (JP); Hidemasa USUI, Saitama (JP); Kazutaka SUZUKI, Saitama (JP); Yosuke YOSHIZAWA, Saitama (JP); Yuko SAKAIDANI, Tokyo (JP)

(21) Appl. No.: 19/064,738

(22) Filed: Feb. 27, 2025

(30) Foreign Application Priority Data
Mar. 29, 2024 (JP) 2024-056424

(51) Int. Cl. H01M 50/48; H01M 50/474

(52) U.S. Cl. CPC H01M 50/48; H01M 50/474

(57) ABSTRACT

Provided is a battery module including: a battery cell stack in which a plurality of battery cells are stacked; a pair of plate members provided at opposite ends of the battery cell stack in a stacking direction; and a cushioning material disposed between the plurality of battery cells and/or between the battery cell stack and each of the plate members, the cushioning material including a corrugated plate spring including a concave portion and a convex portion that are alternately and continuously arranged, and extending in a predetermined direction, wherein on an outer surface or an inner surface of each of the battery cells that faces the cushioning material, a soft resin having a hardness of E40 or less or E60 or more is present.

This application is based on and claims the benefit of priority from Japanese Patent Application No. 2024-056424, filed on 29 Mar. 2024, the content of which is incorporated herein by reference.

### BACKGROUND OF THE INVENTION

### Field of the Invention

The present invention relates to a battery module.

### Related Art

In recent years, research and development of battery modules that contribute to energy efficiency has been carried out in order to ensure many people have access to reasonable, reliable, sustainable, and advanced energy.

A battery module includes, for example, a battery cell stack in which a plurality of battery cells are stacked. Here, because each battery cell expands and contracts with charging and discharging, the battery module includes, for example, a pair of end plates provided at opposite ends of the battery cell stack in a stacking direction, and a bind bar that binds the battery cell stack between the pair of end plates.

Japanese Unexamined Patent Application, Publication No. 2022-156427 describes a power storage device including a power storage module including a plurality of power storage cells stacked in a stacking direction, a housing case housing the power storage module, and a restriction unit disposed between the power storage cells. This restriction unit includes a first flat plate and a second flat plate that are spaced apart in the stacking direction, and a corrugated plate disposed between the first flat plate and the second flat plate.

Patent Document 1: Japanese Unexamined Patent Application, Publication No. 2022-156427

### SUMMARY OF THE INVENTION

In a power storage device described in Japanese Unexamined Patent Application, Publication No. 2022-156427, however, when a restriction unit is compressed due to expansion of power storage cells during charging, a difference in surface pressure increases between portions of first and second flat plates in contact with a corrugated plate and portions of the first and second flat plates that are not in contact with the corrugated plate, which reduces uniformity of a surface pressure loaded on the power storage cells.

An object of the present invention is to provide a battery module capable of increasing a uniformity of a surface pressure loaded on a battery cell.

(1) A battery module includes: a battery cell stack in which a plurality of battery cells are stacked; a pair of plate members provided at opposite ends of the battery cell stack in a stacking direction; and a cushioning material disposed between the plurality of battery cells and/or between the battery cell stack and each of the plate members. The cushioning material includes a corrugated plate spring having concave portions and convex portions that are alternately and continuously arranged, and extends in a predetermined direction. On an outer surface or an inner surface of each of the battery cells that faces the cushioning material, a soft resin having a hardness of E40 or less or E60 or more is present.

(2) In the battery module according to (1), the soft resin is a thermoplastic elastomer, rubber, or cured resin.

(3) In the cushioning material of the battery module according to (1) or (2), a plurality of the corrugated plate springs are stacked in layers in the stacking direction of the battery cell stack, and the corrugated plate springs adjacent to each other have the concave portions and the convex portions in opposing contact with each other.

(4) In the battery module according to any one of (1) to (3), each of the battery cells is a solid-state battery cell.

(5) A method for manufacturing the battery module according to any one of (1) to (4) includes: coating a surface of the battery cell that is to face the cushioning material with a coating liquid containing the soft resin or a precursor of the soft resin.

(6) In the method for manufacturing the battery module according to (5), the precursor of the soft resin is an ultraviolet curable resin, and the method further includes irradiating a surface coated with a coating liquid containing the ultraviolet curable resin with ultraviolet light.

According to the present invention, a battery module capable of increasing uniformity of a surface pressure loaded on a battery cell can be provided.

### BRIEF DESCRIPTION OF THE DRAWINGS

FIG. 1 is a cross-sectional view showing a battery module according to one embodiment of the present invention;

FIG. 2 is a partially enlarged view of the battery module of FIG. 1;

FIG. 3 is an enlarged view of a corrugated plate spring of FIG. 2;

FIG. 4 is a cross-sectional view showing a modification of the battery module of FIG. 2; and

FIG. 5 is a graph showing a relation of variation of surface pressure to hardness of a soft resin of FIG. 2.

### DETAILED DESCRIPTION OF THE INVENTION

Hereinafter, embodiments of the present invention will be described with reference to the drawings.

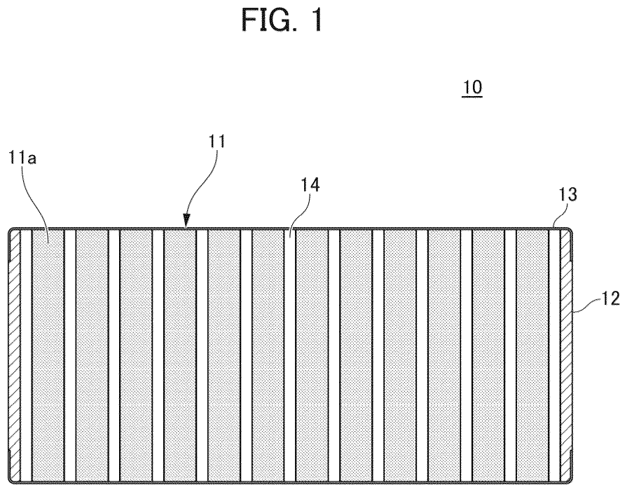

FIG. 1 shows a battery module according to one embodiment of the present invention.

A battery module 10 includes a battery cell stack 11 in which a plurality of battery cells 11a are stacked, end plates 12 as a pair of plate members provided at opposite ends of the battery cell stack 11 in a stacking direction, and bind bars 13 as binding members that bind the battery cell stack 11 between the pair of end plates 12. Here, the bind bars 13 are installed at two locations of upper and lower parts in the drawing, respectively.

In the battery module 10, cushioning materials 14 are arranged between the plurality of battery cells 11a and between the battery cell stack 11 and each of the end plates 12, respectively.

Alternatively, the cushioning material 14 may be disposed between the plurality of battery cells 11a or between the battery cell stack 11 and the end plate 12.

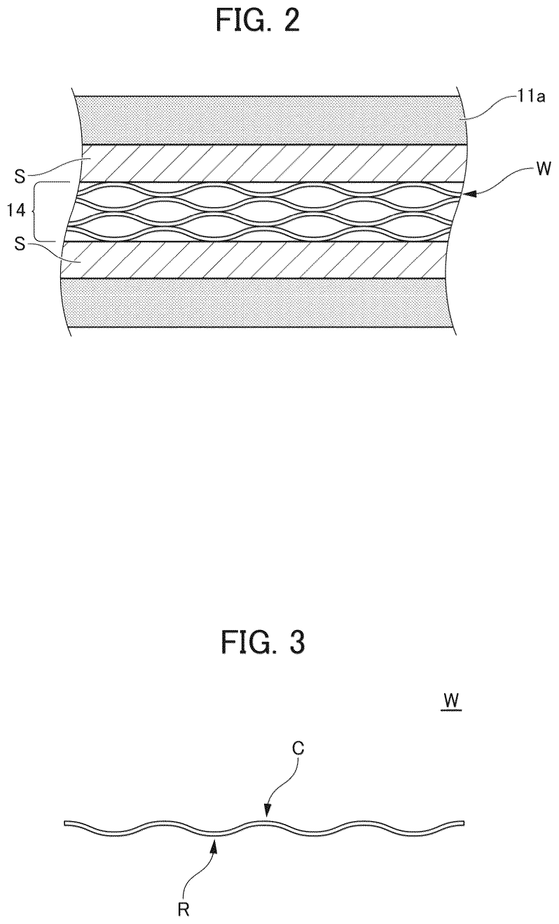

In a cushioning material 14, as shown in FIG. 2, corrugated plate springs W are stacked in a stacking direction of the battery cell stack 11. Furthermore, on an outer surface of each of the battery cells 11a that faces the cushioning material 14, a soft resin S having a hardness of E40 or less or E60 or more is present. Consequently, hysteresis loss of the cushioning material 14 is reduced. As shown in FIG. 3, the corrugated plate spring W has a concave portion R and a convex portion C that are alternately and continuously arranged and extends in a direction of depth in the drawing. In this case, concave portions R and convex portions C of adjacent corrugated plate springs W are in opposing contact with each other. In addition, the concave portion R and the convex portion C protrude downward and upward in the stacking direction of the battery cell stack 11, respectively.

Here, when the cushioning material 14 is compressed as the battery cells 11a expand during charging, a soft resin S is interposed between the battery cell 11a and the cushioning material 14, and hence a difference in surface pressure decreases between a portion of the soft resin S in contact with the cushioning material 14 and a portion of the soft resin S that is not in contact with the cushioning material 14, which increases uniformity of the surface pressure loaded on the battery cell 11a.

The hardness of the soft resin S is E40 or less or E60 or more. When the hardness of the soft resin S is E40 or less or E60 or more, the uniformity of the surface pressure loaded on the battery cell 11a increases. When the hardness of the soft resin S is E40 or less, the hardness of the soft resin S is, for example, E10 or more, and when the hardness of the soft resin S is E60 or more, the hardness of the soft resin S is, for example, E90 or less.

The soft resin S is not particularly limited if the hardness can be E40 or less or E60 or more, and examples thereof include a thermoplastic elastomer such as a polystyrene thermoplastic elastomer, a rubber such as an isoprene rubber or a silicone rubber, and a cured resin such as a cured product of an ultraviolet curable resin.

A thickness of the soft resin S when the battery cell 11a has a charging rate of 100% is not particularly limited, and is, for example, 0.05 mm or more and 0.1 mm or less.

A method of providing the soft resin S on an outer surface of the battery cell 11a that is to face the cushioning material 14 is not particularly limited and is, for example, a method of applying a coating liquid containing the soft resin S or a precursor of the soft resin S.

The precursor of the soft resin S is not particularly limited and is, for example, an ultraviolet curable resin. When the ultraviolet curable resin is used as a precursor to the soft resin S, the ultraviolet curable resin is cured by irradiating the outer surface coated with the coating liquid containing the ultraviolet curable resin with ultraviolet light. The ultraviolet curable resin is not particularly limited and is, for example, an ultraviolet curable acrylic resin or an ultraviolet curable silicone resin.

Alternatively, the soft resin S may be present on an inner surface of the battery cell 11a that faces the cushioning material 14.

The number of stacked corrugated plate springs W is not limited to 2, and is preferably 2 or more and 6 or less, and further preferably 2 or more and 4 or less.

Furthermore, in the adjacent corrugated plate springs W, a part of the concave portion R and convex portion C that are in opposing contact with each other may be bonded, for example, with an elastic adhesive.

Furthermore, as the cushioning material 14, the corrugated plate spring W may be used.

The cushioning material 14 preferably has Young's modulus of 35 GPa or more. When the Young's modulus of the cushioning material 14 is 35 GPa or more, the cushioning material 14 easily absorbs changes in thickness due to expansion and contraction of the battery cell 11a. In addition, the Young's modulus of the cushioning material 14 is, for example, 200 GPa or less.

A material constituting the cushioning material 14 is not particularly limited, and examples thereof include metals such as stainless steel and carbon steel, resins such as epoxy resin, phenol resin and nylon resin, and fiber-reinforced plastic (FRP) such as carbon fiber-reinforced plastic (CFRP) and glass fiber-reinforced plastic (GFRP). In consideration of energy density of the battery module 10, FRP is preferable among these examples.

A thickness of the cushioning material 14 when the battery cell 11a has a charging rate of 100% is not particularly limited, and is, for example, 2 mm or less.

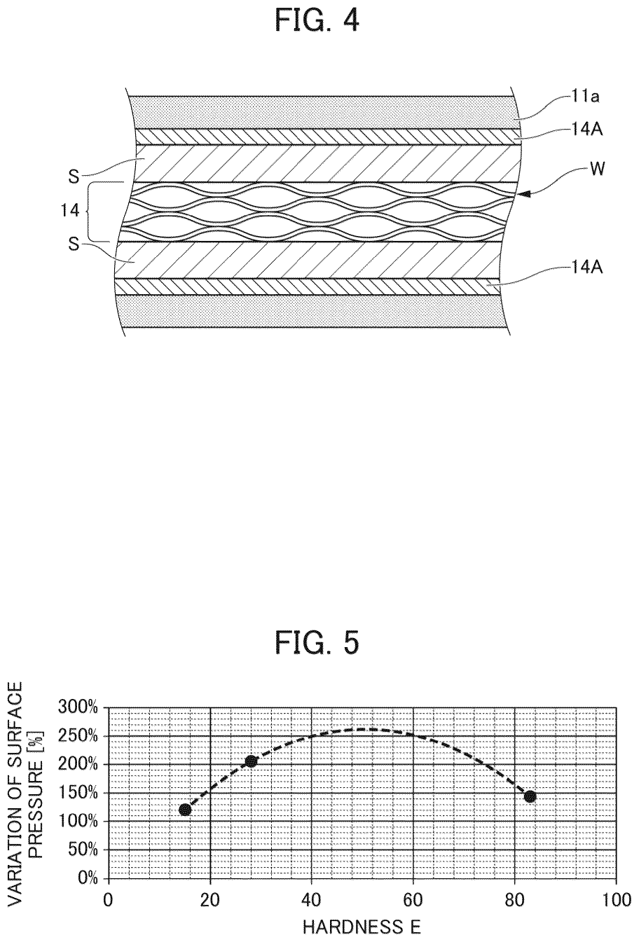

Alternatively, in the battery module 10, an elastic member 14A may be disposed between the battery cell 11a and the soft resin S (see FIG. 4). In this case, the soft resin S is provided on the surface of the elastic member 14A that faces the cushioning material 14.

The elastic member 14A preferably has Poisson's ratio of 0.3 or less. When the Poisson's ratio of the elastic member 14A is 0.3 or less, the elastic member 14A easily absorbs changes in thickness due to the expansion and contraction of the battery cell 11a. In addition, the Poisson's ratio of the elastic member 14A is, for example, 0 or more.

A thickness of the elastic member 14A when the battery cell 11a has a charging rate of 100% is not particularly limited, and is, for example, 0.05 mm or more and 0.1 mm or less.

The elastic member 14A is, for example, a foam having a porosity of 30% or more and 95% or less. A material constituting the foam is not particularly limited, and examples thereof include polyurethane, silicone resin, ethylene propylene rubber, styrene resin, olefin resin, polyamide, and polyester.

FIG. 5 shows a relation of variation of the surface pressure to the hardness of the soft resin S. This surface pressure variation means a ratio of a maximum value of the surface pressure to a minimum value of the surface pressure when a load of 1.0 MPa is loaded on opposite surfaces of the elastic member 14A on which the corrugated plate spring W and the soft resin S are arranged, and the surface pressure on the side of the soft resin S was measured.

It is seen from FIG. 5 that the variation of the surface pressure is reduced with the hardness of the soft resin S being E40 or less or E60 or more.

The battery cell 11a is not particularly limited, and examples thereof include a solid-state battery cell such as an all-solid-state lithium metal battery cell, and a battery cell including an electrolytic solution, such as a lithium metal battery cell. Among these examples, the solid-state battery cell is preferable.

Hereinafter, a case in which the battery cell 11a is an all-solid-state lithium metal battery cell will be described.

In the all-solid-state lithium metal battery cell, for example, a positive electrode current collector, a positive electrode composite layer, a solid electrolyte layer, a lithium metal layer, and a negative electrode current collector are sequentially laminated.

The positive electrode current collector is not particularly limited and is, for example, an aluminum foil.

The positive electrode composite layer contains a positive electrode active material and may further include a solid electrolyte, a conductive aid, a binder, or the like.

The positive electrode active material is not particularly limited if lithium ions can be absorbed and released, and examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}CO_{4/6}Mn_{1/6})O₂, Li(Ni_{1/3}Co_{1/3}Mn_{1/3})O₂, LiCoO₄, LiMn₂O₄, LiNiO₂, LiFePO₄, lithium sulfide, and sulfur.

A solid electrolyte constituting the solid electrolyte layer is not particularly limited if lithium ions can be conducted, and examples thereof include an oxide-based electrolyte and a sulfide-based electrolyte.

The negative electrode current collector is not particularly limited and is, for example, a copper foil.

As above, although embodiments of the present invention have been described, the present invention is not limited to the above embodiments, and the above embodiments may be appropriately altered within the meaning of the present invention.

### EXPLANATION OF REFERENCE NUMERALS

10 battery module
11 battery cell stack
11a battery cell
12 end plate
13 bind bar
14 cushioning material
W corrugated plate spring
S soft resin
R concave portion
C convex portion

What is claimed is:

1. A battery module comprising:
a battery cell stack in which a plurality of battery cells are stacked;
a pair of plate members provided at opposite ends of the battery cell stack in a stacking direction; and
a cushioning material disposed between the plurality of battery cells and/or between the battery cell stack and each of the plate members,
the cushioning material including a corrugated plate spring having concave portions and convex portions that are alternately and continuously arranged, and extending in a predetermined direction, wherein
on an outer surface or an inner surface of each of the battery cells that faces the cushioning material, a soft resin having a hardness of E40 or less or E60 or more is present.

2. The battery module according to claim 1, wherein
the soft resin is a thermoplastic elastomer, rubber, or cured resin.

3. The battery module according to claim 1, wherein
in the cushioning material, a plurality of the corrugated plate springs are stacked in layers in the stacking direction of the battery cell stack, and the corrugated plate springs adjacent to each other have the concave portions and the convex portions in opposing contact with each other.

4. The battery module according to claim 1, wherein
each of the battery cells is a solid-state battery cell.

5. A method for manufacturing the battery module according to claim 1, comprising:
coating a surface of the battery cell that is to face the cushioning material with a coating liquid containing the soft resin or a precursor of the soft resin.

6. The method for manufacturing the battery module according to claim 5, wherein
the precursor of the soft resin is an ultraviolet curable resin,
the method further comprising:
irradiating a surface coated with a coating liquid containing the ultraviolet curable resin with ultraviolet light.
